(19) United States
(12) Patent Application Publication
(10) Pub. No.: US 2012/0224940 A1
(43) Pub. Date: Sep. 6, 2012

(54) Automobile Wheel Changing Tool

(76) Inventor: Dana Andrews, Tacoma, WA (US)

(21) Appl. No.: 13/226,591

(22) Filed: Sep. 7, 2011

Related U.S. Application Data
(60) Provisional application No. 61/410,707, filed on Nov. 5, 2010.

(51) Int. Cl. B60B 29/00

(52) U.S. Cl. 414/426

(57) ABSTRACT

An automobile wheel-changing assistant tool, comprising a base member, a plurality of roller rails with rollers mounted thereto. The roller rails are secured to upstanding walls of the base member and have rollers mounted thereon. The rollers rotate freely about the roller rails and may slide therealong. A tunnel cutout is centrally disposed along the bottom surface of the base member such that a lever arm may be inserted under the device. Once inserted, the upper portion of the lever arm may be pushed downward to lift the device and a tire to be installed. A slider plate comprising a low-friction surface allows the assembly to slide freely when it is placed thereon, allowing easy handling of the device and associated wheel. In use, a tire is placed onto the rollers, slid into position near a vehicle wheel well, pressed forward along the rollers and rotated into position for securement.

### CROSS REFERENCE TO RELATED APPLICATION

This application claims the benefit of U.S. Provisional Application No. 61/410,707 filed on, entitled “Teeter-Tire.”

### BACKGROUND OF THE INVENTION

1. Field of the Invention

The present invention relates to an automotive assistant device. More specifically, the present invention relates to an automobile wheel-changing tool for assisting a user with the installation of an automobile tire.

Flat tires are a common occurrence for automobile travelers. If left unchanged, flat tires can result in damage to an automobile, or can even lead to an auto accident. Motorists who experience flat tires must pull off the roadway and change the tire before proceeding on their journey. Changing a tire usually involves jacking up an automobile; unscrewing lug nuts or lug bolts from a wheel hub, removing the damaged tire, lifting a new tire and into place, and holding the replacement tire while lug nuts are secured in place. This task often proves difficult for the average motorist because of the weight of a tire. Many people find it difficult if not impossible to lift a tire and hold it in position while they secure it to an automobile. Those unable to perform the task may suffer back or neck injury from lifting the heavy tire, or may drop it on their feet. Even if a person is able to successfully change the tire they must exert large amounts of energy.

To reduce the difficulty associated with changing a tire, some car manufacturers provide small, lightweight wheels that can be used to replace a damaged tire. These small wheels, often called “doughnuts” are sufficient for use until a driver can reach a service station, where a full size tire can be installed. However, doughnuts are not suited for use over long distances due to their small diameter, which unbalances the automobile. Motorists who experience flat tires while in remote areas may not have access to a service station, and therefore may have to drive on a doughnut tire for long distances. To solve this problem a portable automotive tool is needed for assisting a user with the changing of an automobile tire so that the user must only perform minimal lifting of the same.

2. Description of the Prior Art

The prior art contains a variety of automotive assistive tools for facilitating the changing of a tire. These devices have familiar design and structural elements for the purposes of changing a tire; however they are not adapted for providing stable positioning of a tire during the process of changing the same.

Roberts, U.S. Pat. No. 5,348,438 discloses a tool for changing an automobile tire. The device comprises a rocker base mounted on wheels, a plurality of rollers, and a foot pedal. The rocker base has a flat upper surface and an arcuate bottom surface. Wheels are secured near the apex of the arcuate bottom surface so the device may be moved forward and backward in alignment with the front and rear of the base. Disposed along the top surface, there is a plurality of rods with rollers attached thereto. A foot pedal is secured to the rear end of the rocker base.

To use the device a person tilts the rocker base so that the rear end is in contact with the ground, and then rolls a tire up onto the rollers. The user may put a foot or knee on the foot pedal to control the height of the front end of the device and thereby control the height of the tire. The tire may be rotated on the rollers to align it with the lugnuts on a wheel hub. The rocking mechanism of Roberts is unstable and relies on a user's ability to continuously apply pressure to the foot pedal to maintain the tire's balance. The present invention does not require any such effort by a user. The present invention includes a level arm for increasing the elevation of the device, instead of the rocker base disclosed by Roberts.

Griesinger, U.S. Pat. No. 4,872,694 discloses a wheel-changing device having a fork-like structure. The device comprises two parallel horizontal arms having rollers attached thereto; a pair of vertical arms having rollers attached thereto, a mainframe plate, and a foot pedal. The mainframe plate is secured to the horizontal and vertical arms and has caster wheels attached to the underside of the plate to assist with moving the device. A tire is rolled up onto the pair of horizontal arms and is supported by the vertical arms. The device may be moved towards or away from a wheel assembly and the tire rotated on the rollers until properly aligned. A user may increase the height of the tire with respect to a wheel assembly by depressing the foot pedal. The device of Griesinger does not contemplate a base member having rollers rotatably mounted thereto to allow rotation of the tire for alignment of the tire lug holes. The base member of the present invention further provides a stable tire support structure that Griesinger does not, wherein the tire is held in a stable position on the device during operation.

Flitton, U.S. Pat. No. 5,176,487 discloses an automotive tool for assisting with the rotating of a wheel assembly. The device comprises a pair of parallel, horizontal roller rails, caster wheels disposed at the ends of said roller rails, a plurality of rollers rotatably secured to said roller rails, and a handle. The device facilitates rotational positioning of a wheel assembly to align the same with a wheel hub for securement. The tool arms are collapsible and may be reconfigured for compact storage of the device aboard a vehicle. Flitton does not contemplate a stabilizing base member. The caster wheels of Flitton result in roller rails that are not level with the ground, thus making the device unbalanced in a resting or unattended position.

Sanchez, U.S. Pat. No. 3,976,212 discloses a device for assisting with the changing of tires on an automobile. The device consists of a pair of parallel, extendable arms, a pair of wheels mounted by swivel joints to the ends of said arms, and a lever handle secured to the rear of said extendable arms. Rollers are rotatably mounted to the extendable arms to allow a tire placed thereupon to rotate. The structure of the device requires that a user lift a tire and place it onto the rollers. A user may then grasp the lever and roll the tire forward or backward towards a wheel well of an automobile. The tire may be rotated while on the rollers to put the former in alignment for securement. Sanchez does not disclose a generally level base member for providing balanced support of a tire.

The devices disclosed by the prior art do not address the need for maintaining a tire in a balanced, stable position. The current invention relates to a device for assisting a user change a tire. It substantially diverges in structural elements from the prior art; consequently it is clear that there is a need in the art for an improvement to the automotive tools for changing a tire. In this regard the instant invention substantially fulfills these needs.

### SUMMARY OF THE INVENTION

In view of the foregoing disadvantages inherent in the known types of automobile tire changing devices now present in the prior art, the present invention provides a new stable base member and positioning means, wherein the same can be utilized for providing convenience for the user when changing a car tire. The present invention comprises a base member, a plurality of rollers rotatably mounted to roller rails and a lever arm for adjusting the position of the base member and supported tire while mounting. The base member has a generally level bottom portion comprising two lower platforms. The platforms attach to and support upstanding walls that extend across a channel that separates the two lower platforms.

A plurality of roller rails extends between the walls of the channel and is secured thereto. Rollers are mounted on the roller rails and are shorter in radius than the height of the upstanding walls to permit the rollers to slide freely along the length of the roller rails and rotated thereabout. When a user rolls a tire onto the device, the surface of the tire rests on the rollers. The tire can then be easily rotated while on the rollers without moving the position of the tire center, or slid forward and backward along the extent of the roller rails. A slide plate having a low-friction surface is included in a preferred embodiment. The slide plate may be placed on the ground near a wheel well and the device placed thereupon. When a tire is resting on the device, the assembly can be moved along the slide plate without unbalancing the tire or requiring large amounts of force by the user. These sliding capabilities allow the tire to be moved into place for securement of lug nuts that attach the tire wheel to the vehicle wheel hub. In an alternative embodiment, the device may have rotatable wheels secured to the base of the device to provide improved moving means.

To further promote ease of positioning the tire, a lever arm tool is provided for increasing the height of the device and tire. The lever arm may have the shape of two straight, flat bars that are displaced and connected by a diagonal flat bar. An end of the lever arm may be placed in the channel between the bottom plate portions, while the opposing end of the lever arm may then be pressed downward to raise or angle the device above ground. This allows for minute adjustment of the tire as it is being attached, as well as an elevated means to rest the tire as it is being removed.

It is therefore an object of the present invention to provide a new and improved automobile wheel-changing device having all the advantages of the prior art and none of the disadvantages.

Another object of the present invention is to provide a new and improved automobile wheel-changing device having a plurality of rollers that slide along roller rails such that a tire resting on the rollers may easily be moved into position for securement.

Yet another object of the present invention is to provide a new and improved automobile wheel-changing device having a plurality of rollers facilitating rotational and fore-aft positioning of a tire resting thereon.

Still another object of the present invention is to provide a new and improved automobile wheel-changing device having a generally level resting position to promote balance and stability of a tire resting on the device.

Another object of the present invention is to provide a new and improved automobile wheel-changing device having a low friction slide plate that allows the device to be moved without unbalancing a tire resting thereon.

A further object of the present invention is to provide a new and improved automobile wheel-changing device having resilient, durable and relatively inexpensive construction.

Other objects, features and advantages of the present invention will become apparent from the following detailed description taken in conjunction with the accompanying drawings.

### BRIEF DESCRIPTIONS OF THE DRAWINGS

The above invention will be better understood and the objects set forth above as well as other objects not stated above will become more apparent after a study of the following detailed description thereof. Such description makes use of the annexed drawings wherein like numeral references are utilized throughout.

FIG. 1 shows a perspective view of the present automobile wheel-changing device with a lever arm in position for use.

FIG. 2 shows a side view of the present automobile wheel-changing device.

FIG. 3 shows another side view of the present automobile wheel-changing device.

FIG. 4 shows a side view of the present automobile wheel-changing device while in use.

FIG. 5 shows a perspective view of the present automobile wheel-changing device positioned on a sliding mat.

### DETAILED DESCRIPTION OF THE INVENTION

Reference is made herein to the attached drawings. Like reference numerals are used throughout the drawings to depict like or similar elements of the automobile wheel-changing device. For the purposes of presenting a brief and clear description of the present invention, the preferred embodiment will be discussed as used for assisting a user with changing the tire of an automobile. The drawings are intended for illustrative purposes only and should not be considered to be limiting in any respect.

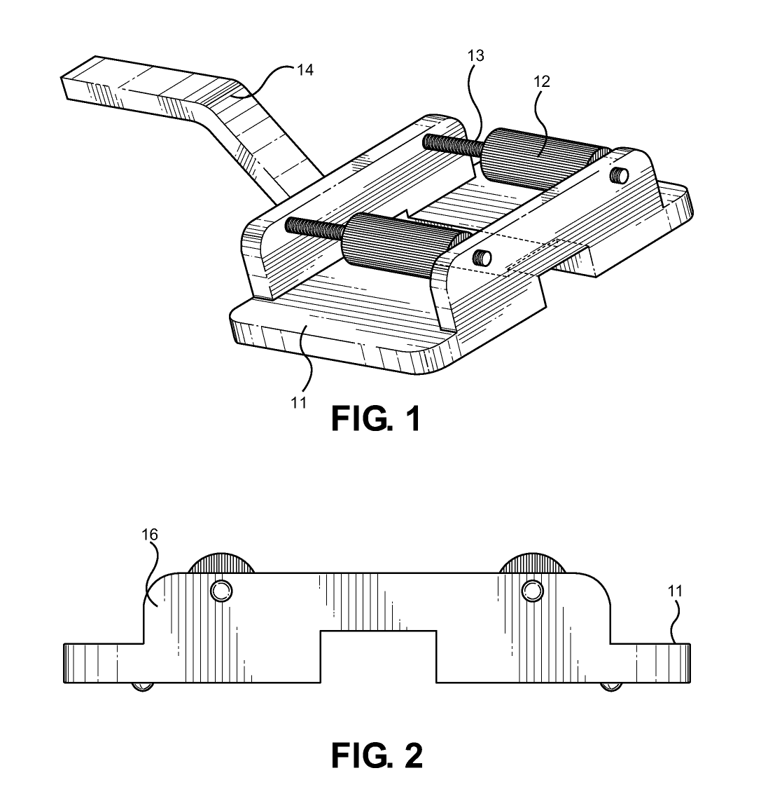

Referring now to FIG. 1, there is shown a perspective view of the present automobile wheel-changing device. The device comprises a base member 11, a plurality of rollers 12 rotatably mounted to roller rails 13, as well as a lever arm 14. The base member has a flat bottom surface that promotes level alignment of the device with respect to the ground. In a preferred embodiment, the roller rails and rollers mounted thereto are in parallel alignment and are level with the bottom surface of the base member. In alternative embodiments, there may be several roller rails, the inner arms being positioned closer to the ground so as to present an overall concave shape for receiving a tire. These alignments promote balanced retention of a tire resting on the device so that a user may have the use of both hands to complete other tasks.

The lever arm 14 is separate from the main body of the device and is used for increasing the height of the device and a tire resting thereon. The lever arm may be a long rectangular bar formed in a shape wherein two parallel portions are connected by a diagonal portion. Either end may be placed under the device so that the lower end lies flat on the ground and the upper end is in the air. A user may then press down on the upper end of the lever arm to lift the lower end of the same into the air, thereby lifting up the device and the tire. This lever arm may be made of metal, plastic or any other durable, load-bearing material.

Referring now to FIG. 2, there is shown a side view of the device from an upper or lower edge of the base member 11. The base member consists of two platforms separated by a channel. Two upstanding walls 16 are disposed along the device and span the channel between the two platforms. The upstanding walls extend across the platforms and terminate prior to the opposing edges thereof. As shown in FIG. 2, the walls may extend across approximately two-thirds of each platform, resulting in an open portion at the lateral edges of the platforms. The platforms extend further out to provide improved stability, while the channel is provided to receive the length and width of the lever arm. The base member is preferably formed of extruded or injection molded plastic; however alternate materials include machined or fastened metallic elements, or any other durable material contemplated by one skilled in the art of tire changing devices.

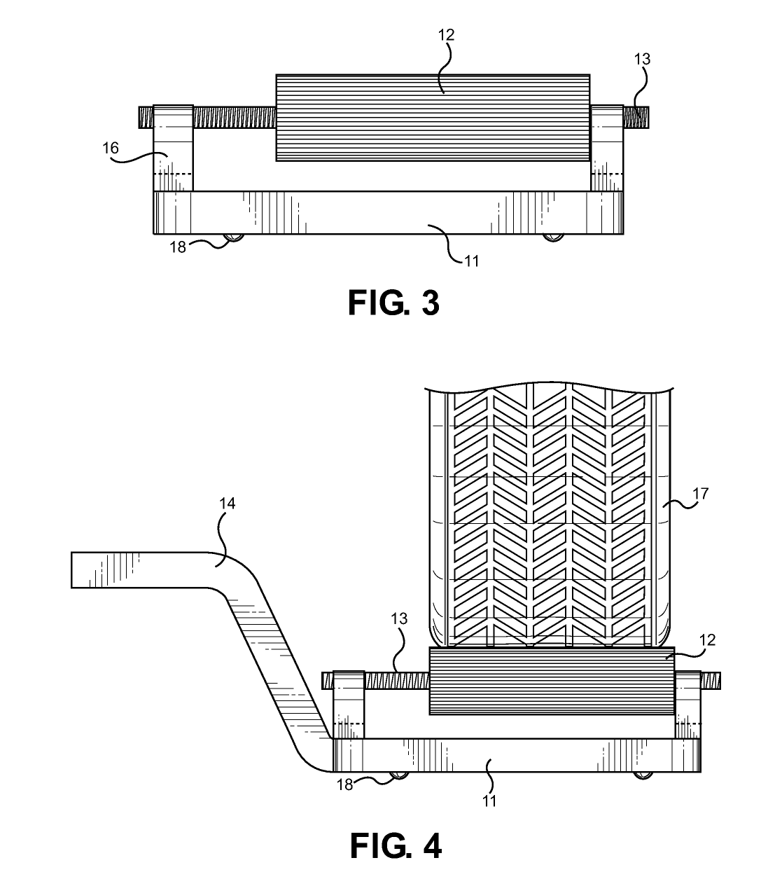

Referring now to FIG. 3, there is shown a side view of the device from a lateral edge. A plurality of rollers 12 is secured to roller rails 13 of the base member, and extends between the two upstanding walls 16. In a preferred embodiment, the roller rails 13 are cylindrical bars having a smooth outer surface. These bars are secured to the channel walls by insertion through apertures in the same, preventing rotation or dislocation thereof. A cylindrical roller is rotatably mounted to each roller rail. The length of a roller is less than the distance between the interior surfaces of the upstanding walls. This allows the rollers to slide along the length of each roller rail so that a tire resting on the rollers can be moved forward and backward with respect to the user. The rollers may have smooth outer surfaces or may include surface ridges to promote better grip on a tire. If a roller is damaged during use it may be replaced by removing the roller rail from one of the upstanding walls, sliding the damaged roller from the roller rail, sliding a new roller onto the rail and then replacing the rail into the upstanding wall apertures. A roller set screw may be utilized through an aperture in the upstanding walls to retain the position of the rails once installed on the device. The roller rails and rollers themselves may be formed of plastic, metal or any other durable load-bearing material.

Referring now to FIG. 4 there is shown a side view of the device while in use. A tire 17 is resting on the device, rotatably and positionally supported by the rollers 12. The device rests in a balanced position that is parallel with the ground. The tire may be slid forward or backward along the length of the roller rails 13 by sliding the rollers 12 thereon. The lever arm 14 is placed between the base platforms where it may be used to lift the device and tire 17 to a desired height. In this view, an alternate bottom surface feature is provided, wherein rounded nubs 18 disposed at the corners of the base platforms assist with balance, support and reduced friction of the device. In another alternative, these nubs 18 may be roller balls or rotatable wheel structures to facilitate movement of the device while positioning a tire 17.

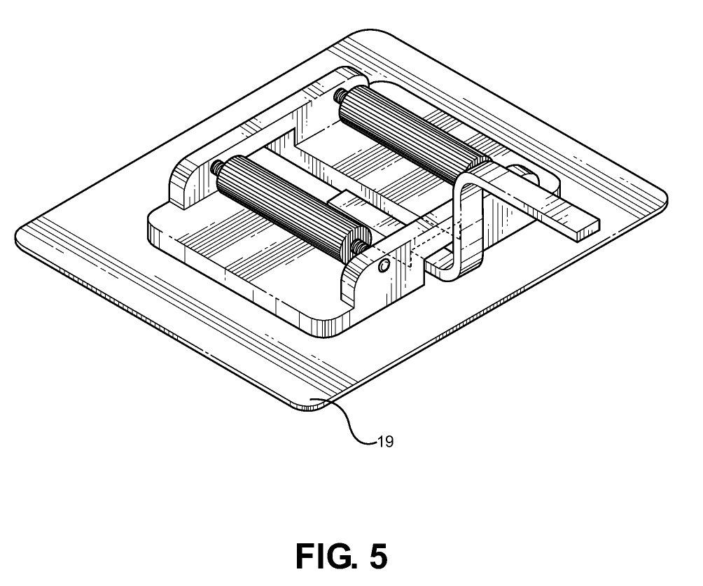

Referring now to FIG. 5 there is shown a perspective view of the present automobile wheel changing device. The preferred embodiment of the device includes a slide plate 19 having a low-friction surface. The slide plate may be placed on the ground in front of a wheel well such that when the device is placed thereon, the device's position may be adjusted by sliding it along the plate with minimal effort. Alternatively, the optional hemispherical nubs may be replaced with spherical wheels that allow the device to roll freely in any direction. The spherical wheels may be depressible within the lower platforms so that the device may remain level even on uneven ground. In another embodiment, the device may have swivelable wheels secured to the bottom surface of the platforms. These wheels allow the device to roll freely in any direction.

In use, an individual places the slider plate on the ground under a wheel and then places the device thereon. The user then removes the damaged tire from the vehicle wheel hub assembly and lowers the tire onto the device. The device may then be slid along the slider plate to move the tire away from the automobile. A user then removes the damaged tire from the device, after which a new tire is rolled onto the device such that the tire is supported on the rollers. The device is then slid forward towards the wheel well. Once the tire is positioned next to the vehicle wheel hub assembly, it may then be rotated on the rollers to align the tire for insertion of lug bolts. If height adjustment is necessary, the lever arm can be inserted under the device and the upper portion of the lever arm depressed to lift the device and tire into the air. The tire is then pushed onto the vehicle wheel hub and secured in place via lug nuts or lug bolts. In this manner, a user may change an automobile tire without having to lift the tire, thereby reducing the risk of injury.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim the following:

1) An automotive tool for assisting a user changing an automobile tire, comprising:
a base member having upstanding walls;
a plurality of roller rails secured to and between said upstanding walls;
a plurality of rollers rotatably and slideably mounted to said roller rails.

2) A device as in claim 1, wherein said base member further comprises a channel adapted to fit a lever arm for lifting said base member.

3) The device of claim 1, wherein said roller rails are parallel with a bottom surface of said base member.

4) The device of claim 1, wherein said plurality of roller rails comprises three or more rollers having an arcuate alignment adapted to receive a wheel.

5) The device of claim 1, further comprising a slide plate having a low-friction upper surface to facilitate sliding of said base member on said slide plate.

6) The device of claim 1, further comprising hemispherical nubs secured to a bottom surface of said base member.

7) The device of claim 1, further comprising wheels secured to a bottom surface of said base member.

8) The device of claim 7, wherein said wheels are spherical.

9) The device of claim 7, wherein said wheels are secured by swivel joints.

10) An automotive tool for assisting a user changing an automobile tire, comprising:
a base member having upstanding walls;
a plurality of roller rails secured to and between said upstanding walls;
a plurality of rollers rotatably and slideably mounted to said roller rails;
said base member further comprises a channel adapted to fit a lever arm for lifting said base member.

11) The device of claim 10, wherein said roller rails are parallel with a bottom surface of said base member.

12) The device of claim 10, wherein said plurality of roller rails comprises three or more rollers having an arcuate alignment adapted to receive a wheel.

13) The device of claim 10, further comprising a slide plate having a low-friction upper surface to facilitate sliding of said base member on said slide plate.

14) The device of claim 10, further comprising hemispherical nubs secured to a bottom surface of said base member.

15) The device of claim 10, further comprising wheels secured to a bottom surface of said base member.

16) The device of claim 15, wherein said wheels are spherical.

17) The device of claim 15, wherein said wheels are secured by swivel joints.
